(19) United States
(12) Patent Application Publication
(10) Pub. No.: US 2019/0108582 A1
(43) Pub. Date: Apr. 11, 2019

(54) SYSTEMS AND METHODS FOR REFUNDING QR AND OTHER PAYMENT SYSTEM TRANSACTIONS

(71) Applicant: Mastercard International Incorporated, Purchase, NY (US)

(72) Inventors: Smita Sebastian, Scarsdale, NY (US); Pablo Fourez, White Plains, NY (US); Shawn Eric Hagmeier, St. Peters, MO (US); Mary K. Rechert, Lake St. Louis, MO (US); Dennis J. Hill, O'Fallon, MO (US)

(21) Appl. No.: 16/152,821

(22) Filed: Oct. 5, 2018

Related U.S. Application Data
(60) Provisional application No. 62/569,850, filed on Oct. 9, 2017.

(51) Int. Cl. G06Q 40/02; G06K 19/06; G06K 7/14; G06Q 30/02

(52) U.S. Cl. CPC G06Q 40/02; G06Q 30/0215; G06K 7/1417; G06K 19/06037

(57) ABSTRACT

A digital account reference is associated with a user's account. A refund message is received. The refund message includes the digital account reference. A monetary amount is credited to the user's account based on the refund message. A notification is transmitted to the user. The notification is about the credit to the account. The transmission of the notification occurs immediately after the refund message is received.

### CROSS REFERENCE TO RELATED APPLICATION

This application claims the benefit of U.S. Provisional Patent Application No. 62/569,850 (filed on Oct. 9, 2017); the contents of which provisional application are hereby incorporated by reference for all purposes.

### BACKGROUND

Various types of payment system transactions on occasion need to be reversed or adjusted, with refunding of the amount charged to the account which funded the original transaction. It would be desirable for the refund transactions to be executed in real time or close to real time, using existing payment system network facilities, and regardless of whether the funding account is a payment account recognized in the payment system network, a bank account, or another type of account.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and example embodiments and which are not necessarily drawn to scale, wherein:

FIG. 1 is a block diagram that illustrates a payment system in which aspects of the present disclosure may be applied.

FIGS. 2 and 3 are block diagrams that illustrate example computer systems that each may play a role in the payment system of FIG. 1.

FIG. 3A is a simplified block diagram of a typical mobile device of a type that may perform one or more functions in the payment system of FIG. 1.

FIG. 4 is a flow chart that illustrates an example or a framework of a process that may be performed according to aspects of the present disclosure in the payment system of FIG. 1.

FIGS. 5 and 6 are additional flow charts that illustrate processes that may be performed in the payment system of FIG. 1.

### DESCRIPTION

In general, and for the purpose of introducing concepts of embodiments of the present disclosure, digital account references may be mapped to consumers' accounts and may be included in transaction messaging by routing through a payment system using the digital account references. The digital account reference may be in the same format as payment account numbers used to route transactions in the payment system. In some embodiments, at least some of the digital account references may be VPANs (virtual primary account numbers). The digital account references may be used to facilitate immediate execution of refund transactions when necessary. The generation/mapping of the digital account reference to the consumer's account may occur when the consumer registers for a service offering by the consumer's bank, or at another time determined by the consumer's bank. In some embodiments, the consumer's bank may request and receive a digital account reference upon enrollment of a consumer/consumer's account for certain payment account system transaction capabilities. In other embodiments, the payment network may serve in an “on behalf” basis for the consumer's bank to generate a digital account reference upon the consumer bank's first transaction request for a given consumer account.

At the point of sale, when a refund transaction is needed, the merchant may operate a mobile device (for example) to select a transaction reference. The merchant may operate the mobile device to request the refund transaction using the transaction reference. The refund transaction messaging may utilize the VPAN that represents the customer's account.

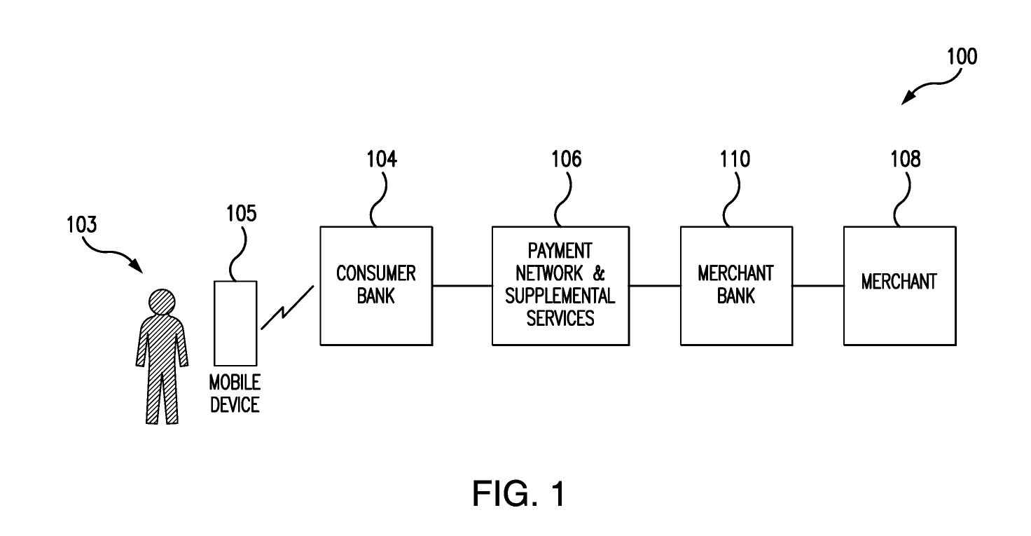

FIG. 1 is a block diagram that illustrates a payment system 100 in which aspects of the present disclosure may be applied. FIG. 1 should be taken to illustrate a general framework for such a system, and some ensuing descriptions of other embodiments of the system may refer to an additional party, device, parties or devices not explicitly shown in FIG. 1.

A consumer/individual user/customer 103 is shown in FIG. 1. The consumer 103 may initiate transactions in the payment system 100 and may on occasion be the recipient of a refund pursuant to a refund transaction such as those described herein. In some embodiments, the consumer 103 may employ a suitably programmed smartphone or other mobile device (reference numeral 105) to engage in payment account system transactions and to receive notifications, on occasion, of refund transactions. The mobile device 105 employed by the consumer 103 may be conventional in its hardware aspects and need not necessarily be programmed in a novel manner, although some customized programming will be implied in some use cases described below.

Block 104 represents the consumer's bank—i.e., a bank that issues an account to the consumer; the account in question may be used to fund transactions as described herein, and may on occasion receive push payment transactions that represent refund transactions. (The bank 104 may also be referred to as a customer bank.) The account in question may be, for example, a payment system account (e.g. a credit or debit account), a bank deposit account, or another type of account, such as those mentioned in certain examples below. The other types of accounts may include a mobile money account, or a staged wallet account. Where the account is a payment system account, the consumer bank 104 may be referred to as an “issuer” in payment account system parlance. Although not shown in the drawing, a wallet service provider (WSP) may be involved and may facilitate a wallet program for which a digital account reference or references are assigned.

Block 106 represents a payment network and also incorporates computer resources for providing additional or supplemental services in accordance with concepts introduced in this disclosure.

One well known example of a payment network is referred to as the “Banknet” system, and is operated by Mastercard International Incorporated, which is the assignee hereof.

Block 108 in FIG. 1 represents a merchant with which the consumer 103 engages in a payment account system transaction. Block 108 may also be taken to represent a merchant's POS (point of sale) device or other device (e.g., a suitably programmed mobile device) which performs some function or functions for the merchant 108 in connection with a payment system transaction.

Block 110 represents the merchant's bank; in payment system parlance the merchant bank 110 may sometimes be referred to as an “acquirer” or “transaction acquirer”.

The components of the system 100 as depicted in FIG. 1 are only those that are needed for processing a single transaction. In a practical embodiment, the payment system may process many transactions (including simultaneous transactions) and may include a considerable number of customer and merchant banks and their computers, and numerous merchants. The system may also include a very large number of consumers, each of whom may have one or more mobile devices and/or other computing devices

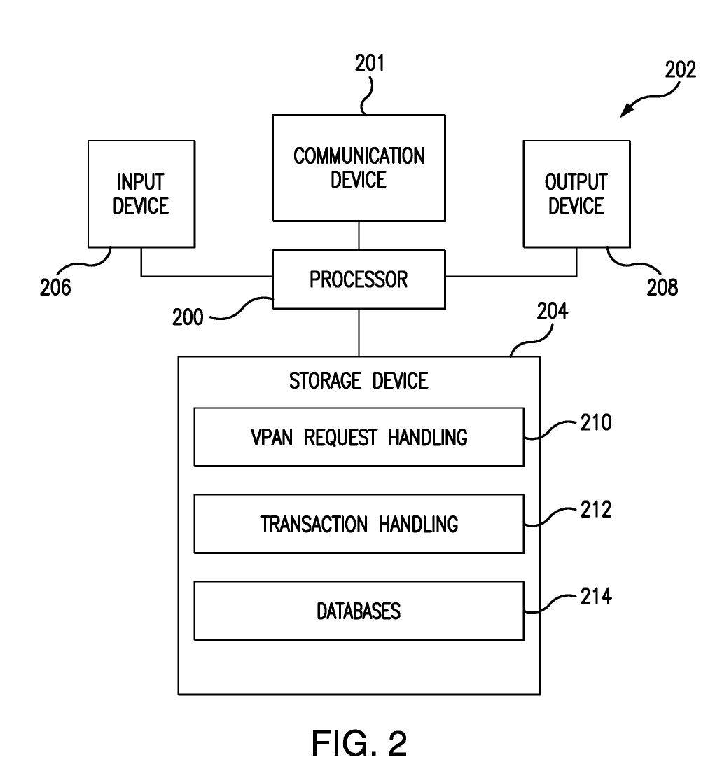

FIG. 2 is a block diagram that illustrates an example embodiment of a computer system 202 that may implement some or all of the functionality of block 106 of FIG. 1. Accordingly, the computer system of FIG. 2 may be referred to as the “payment network computer”.

In some embodiments, the payment network computer 202 may take the form of a server computer and/or mainframe computer. The payment network computer 202 may, in its hardware aspects, resemble a typical server or mainframe computer, but may be controlled by software to cause it to function as described herein.

The payment network computer 202 may include a computer processor 200 operatively coupled to a communication device 201, a storage device 204, an input device 206 and an output device 208. The communications device 201, the storage device 204, the input device 206 and the output device 208 may all be in communication with the processor 200.

The computer processor 200 may be constituted by one or more processors. Processor 200 operates to execute processor-executable steps, contained in program instructions described below, so as to control the payment network computer 202 to provide desired functionality.

Communication device 201 may be used to facilitate communication with, for example, other devices (such as consumer bank computers and merchant bank computers). Communication device 201 may comprise numerous communication ports (not separately shown), to allow the payment network computer 202 to communicate simultaneously with a large number of other computers, including communications as required to simultaneously handle numerous transactions and other requests.

Input device 206 may comprise one or more of any type of peripheral device typically used to input data into a computer. For example, the input device 206 may include a keyboard and a mouse. Output device 208 may comprise, for example, a display and/or a printer.

Storage device 204 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 204 stores one or more programs for controlling processor 200. The programs comprise program instructions (which may be referred to as computer readable program code means) that contain processor-executable process steps of the payment network computer 202, executed by the processor 200 to cause the payment network computer 202 to function as described herein.

The programs may include one or more conventional operating systems (not shown) that control the processor 200 so as to manage and coordinate activities and sharing of resources in the payment network computer 202, and to serve as a host for application programs (described below) that run on the payment network computer 202.

The programs stored in the storage device 204 may include, for example, a digital account reference request handling application program 210. Functionality provided by this program will be described below.

In addition, the storage device 204 may store a transaction handling application program 212. The transaction handling application program 212 may encompass all the functionality typically provided by a payment network including processing and routing of authorization requests and authorization responses. The transaction handling application program 212 may also provide additional functionality as described below in connection with various use cases and processes that represent teachings of the present disclosure.

The storage device 204 may also store, and the payment network computer 202 may also execute, other programs, which are not shown. For example, such programs may include a reporting application, which may respond to requests from system administrators for reports on the activities performed by the payment network computer 202. The other programs may also include, e.g., device drivers, database management programs, communications software, etc.

The storage device 204 may also store one or more databases (reference numeral 214) required for operation of the payment network computer 202.

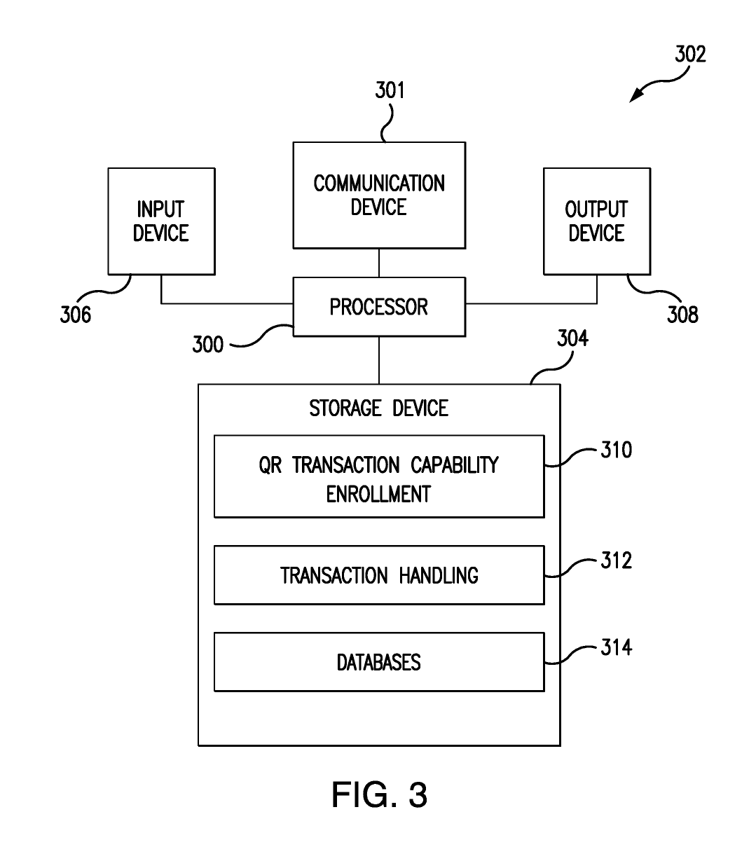

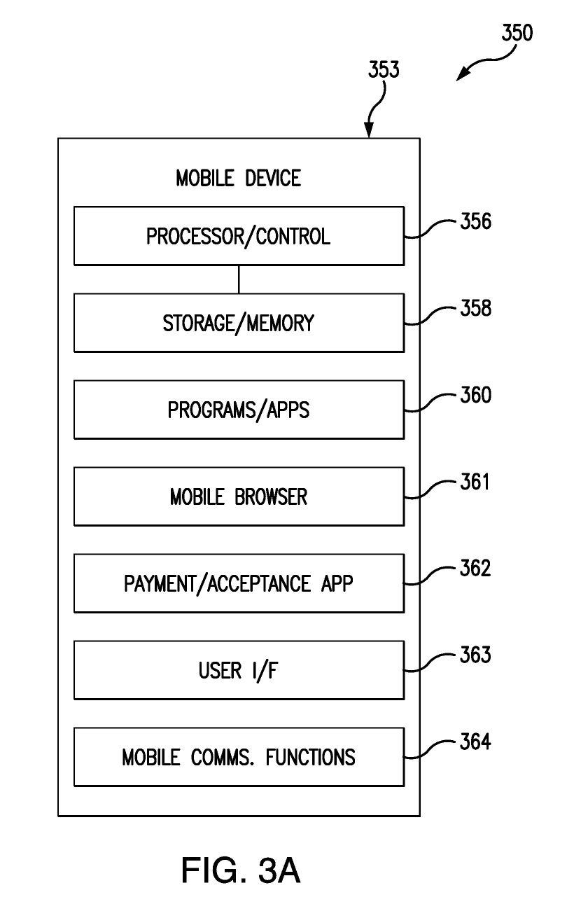

FIG. 3 is a block diagram that illustrates an example embodiment of a computer system 302 that may implement some or all of the functionality of block 104 of FIG. 1. Accordingly, the computer system of FIG. 3 may be referred to as the “consumer bank computer”.

It should be noted that the consumer bank computer 302 shown in FIG. 3 may be similar in its hardware architecture and components to the payment network computer 202 depicted in FIG. 2. Thus the consumer bank computer 302 may include a processor 300, a communication device 301, a storage device 304, an input device 306 and an output device 308.

The general discussion of software and data aspects of the payment network computer 202 is also applicable to the consumer bank computer 302, apart from some differences in the application programs. Storage device 304 may store a consumer enrollment application program 310. The consumer enrollment application program may control the consumer bank computer 302 to onboard new users and/or enable them to engage in new sorts of payment system transactions. As will be understood from subsequent discussion, part of such enrollment processing may include requesting digital account references for mapping to accounts that the consumers wish to use to fund payment account system transactions.

The storage device 304 may also store a transaction handling application program 312. The transaction handling application program 312 may program the consumer bank computer 302 to perform functions relating to payment account system transactions, including refund transactions as described herein. The functionality provided by the transaction handling application program 312 may encompass functions typically performed by consumers' banks' computers in connection with payment account system transactions as well as additional functionality as described herein.

From the discussion of FIG. 2, it will be appreciated that the storage device 304 may also store one or more databases (reference numeral 314) required for operation of the consumer bank computer 302.

The merchant bank may also operate a computer or computers (not separately shown). The merchant bank computer may have components and a hardware architecture as shown and discussed relative to the payment network computer 202 (FIG. 2), and may be programmed to provide functionality as described herein.

FIG. 3A is a simplified block diagram of typical mobile device 350 that exemplifies the mobile device 105 shown in FIG. 1 and/or a mobile device of a kind that may be employed by a merchant 108 according to some embodiments of this disclosure. In this example embodiment, the mobile device 350 is assumed, without limitation, to be a smartphone.

Referring now to FIG. 3A, the mobile device 350 may include a housing 353, which may be shaped and sized to be held in the user's hand. The mobile device 350 further includes a processor/control circuit 356, which is contained within the housing 503. Also included in the mobile device 350 is a storage/memory device or devices (reference numeral 358). The storage/memory devices 358 are in communication with the processor/control circuit 356 and may contain program instructions to control the processor/control circuit 356 to manage and perform various functions of the mobile device 350. Programs/applications (or “apps”) that are stored in the storage/memory devices 358 are represented at block 360 in FIG. 3A, and may be accessed to program the processor/control circuit 356. A browser program 361 is shown separately from the programs/apps 360. Moreover, a payment app or payment acceptance app (as the case may be) is represented separately by block 362. The browser app 361 and/or the payment app/payment acceptance app 362 may also program the processor/control circuit 356.

Physical and/or software aspects of the device user interface, including input/output (I/O) devices, are represented at block 363 in FIG. 3A. Block 363 should also be taken to represent a touchscreen (not shown apart from block 363), which may play a major role in the I/O functionality of the mobile device 350.

As is typical for mobile devices, the mobile device 350 may include mobile communications functionality as represented by block 364. The mobile communications functionality 364 is constituted by hardware (e.g., an antenna, a transceiver) and software aspects that allow the mobile device 350 to engage in data communication with other devices. For example, the mobile communication functionality 364 may encompass voice and data communications via a mobile communications network (not shown).

From the foregoing discussion, it will be appreciated that the blocks depicted in FIG. 3A as components of the mobile device 350 may in effect overlap with each other, and/or there may be functional connections among the blocks which are not explicitly shown in the drawing.

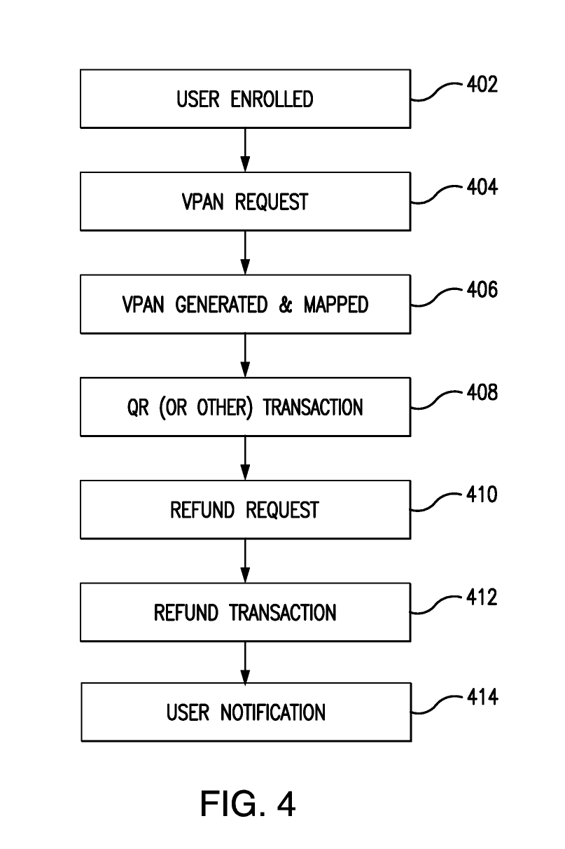

FIG. 4 is a flow chart that illustrates a process or framework of processes that may be performed according to aspects of the present disclosure in the payment system 100.

At 402, the consumer/user 103 is enrolled by the consumer bank 104 for one or more kinds of payment transactions to be performed via the “rails” of the payment network 106. In the event that the account to be used for the funding of the transactions is not issued under the auspices of the payment network 106, then the consumer bank 104 may request (from block 106, the payment network, etc.) a digital account reference to be mapped to the consumer's account. The digital account reference request is represented at block 404 in FIG. 4. Generation of the digital account reference by the payment network 106 and mapping of that digital account reference to the consumer account in question are represented at block 406 in FIG. 4. All future payment account system transactions using the account in question may utilize the digital account reference in transaction requests and in a possible future refund transaction involving the account. (As mentioned below, the consumer bank may itself generate and assign digital account references.)

At 408, the consumer 103 engages in a so-called “QR” transaction, or in a transaction of another kind as discussed in alternative examples and use cases below. In earlier patent applications having a common assignee with this application, various techniques have been disclosed in which payment transactions may be initiated by using a suitably programmed smartphone to scan a QR (quick response) code or other type of barcode. These earlier applications have been assigned U.S. Patent and Trademark Office application Ser. No. 14/050,974 (“the “’974 application”) and Ser. No. 14/980,968 (the “’968 application”) and have been published as U.S. patent publication nos. 2014-0101036 and 2016-0155112. These earlier applications are incorporated herein by reference.

In some QR transactions, the consumer's smartphone is used to scan a QR code proffered by the merchant, in order to capture merchant details. The QR code may be static and so may not indicate the transaction amount. It is part of the consumer's role in such cases to key the transaction amount into his/her smartphone via a virtual keypad presented by the smartphone touchscreen.

For present purposes, it will be assumed that the consumer has made an error in keying the transaction amount, and that this error was not noticed before the consumer launched the transaction. It will be further assumed that the error is noticed almost immediately after by either the consumer or the merchant. (E.g., the merchant's notification on the merchant's smartphone that the transaction has gone through may indicate the incorrect transaction amount, which the merchant may notice.) Accordingly, the merchant—as indicated at block 410 in FIG. 4—may operate his/her smartphone to request the merchant bank to refund the transaction. In some embodiments, the merchant may touch on a transaction reference number (also referred to as a “transaction reference”) displayed on his/her smartphone touch screen to raise an option on the smartphone to initiate the refund request. Upon actuating this option, the merchant's smartphone sends a refund request message to the merchant bank. The merchant bank then initiates the refund transaction to push the funds to the consumer's account. The refund transaction itself is indicated at 412 in

FIG. 4. According to aspects of this disclosure, the digital account reference for the consumer's account is included in the refund transaction messaging from the merchant bank through the payment network to the consumer bank. According to aspects of this disclosure, the refund transaction may be of a special type and may arrive at the consumer bank with a mandate that the consumer's bank immediately notify (block 414) the consumer of the refund transaction, and that the consumer bank credit the consumer's account with the refund in real time or in near real time (within 30 minutes or less).

Because of the mapping from the digital account reference to the consumer's account, the refund transaction may occur rapidly via the payment network rails, with refunding to the consumer's account even if the consumer's account is not a credit, debit or other account issued under the payment network's auspices. In the refund messaging, the payment network may also provide the consumer's original funding source to help simplify the reconciliation process for the banks.

The refund transaction may involve the consumer bank receiving a refund message originating from the merchant bank. The refund message may be a push payment message to push funds from the merchant bank to the consumer bank. The refund message may be received via the payment network 106 (i.e., via a payment card account system network). The refund message may be in a standard message format prescribed by the payment card account system. The refund message may contain the original account reference, which the consumer bank may decode to obtain account information that identifies the consumer account to which the original transaction was charged.

In an example described above, the consumer initiated a payment account system transaction by scanning a merchant's QR code with the consumer's smartphone to capture merchant details. Alternatively, however the smartphone may capture the merchant details in another way, such as via NFC communication or Bluetooth “low energy” communication with a merchant device.

Refund transactions with immediate push of funds to the consumer's account may also be applied in other use cases, such as a return of physical goods to a merchant's retail store, mailing goods for return in connection with an e-commerce transaction, returns of goods purchased via a conventional merchant-initiated purchase transaction at a merchant point of sale, and reversal of so-called P2P, disbursement, bill pay and agent cash out transactions. The latter use cases may occur, for example, when the funds transfer recipient is not expecting the payment and requests that the payment be reversed.

One advantage of processes that are described herein is that the processes are automated and may quickly and efficiently adjust or correct user error in keying in the purchase amount. The teachings of the present disclosure may produce a good user experience by real time notification to the consumer and the merchant. The teachings of the present disclosure may allow for rapid refunds with minimal additional cost or effort for merchant banks and for consumer banks or other originating institutions.

The merchant may be protected in the processes disclosed herein because the refund transaction may occur only in response to merchant approval of the refund.

One important advantage is that refunds are supported (via the digital account reference feature) even to “non-card” funding accounts.

It may be advisable, where the funding is a “card account” recognized by the payment network, that the funding card account be credited instantly as part of the refund-for-return scenario.

It may generally be advisable that the refund transaction reverse the interchange that occurred in the original transaction.

It may be advisable that the digital account reference-based refund transaction functionality be accessible to participant banks via either one of an API interface and an MIP interface.

In a use case already referred to in part, the consumer makes a payment for purchase of goods by keying in the transaction amount to his/her smartphone (e.g., in a QR transaction). The consumer bank initiates a real time funding transaction to pull from the consumer's card account. The payment network routes the transaction to the merchant bank to credit the merchant's card account that backs the program for transactions of this kind. The merchant card account can be a virtual PAN and can be locked down so that the account can only receive payments and no funds can be pulled from the card account. The merchant bank receives the payment request. The merchant receives notification that the payment transaction has been performed with the notification coming to the merchant's smartphone via a merchant app or as an SMS notification. Then, as indicated in a scenario described above, the consumer or merchant notices that the wrong amount was keyed in. The merchant may click on the transaction reference in the mobile app to reverse/cancel the transaction. A suitable message then is sent from the merchant smartphone to the merchant bank to request the refund transaction. The refund transaction is performed and the consumer is notified of the refund transaction via the consumer's smartphone.

In a return-of-goods use case, the consumer makes a payment account system transaction payment for the purchase of the goods. The payment network routes the transaction to the merchant bank to credit the merchant's card account that backs the program for transactions of this kind. (As an alternative to a card account, the merchant could be backed by a bank deposit account, in which case a virtual PAN may be assigned to the merchant bank.) The merchant bank receives the payment request. The merchant receives notification that the payment transaction has been performed with the notification coming to the merchant's smartphone via a merchant app or as an SMS notification. A number of days later, the consumer comes back to the merchant location to return goods. The consumer provides a transaction reference number to the merchant. The merchant looks up the original transaction using the reference number. The merchant may click on the transaction reference in the mobile app to reverse/cancel the transaction. A suitable message then is sent from the merchant smartphone to the merchant bank to request the refund transaction. The refund transaction is performed and the consumer is notified of the refund transaction via the consumer's smartphone. In some embodiments and/or in some situations, the consumer may provide the reference number or other reference information to the merchant by displaying a suitable QR code on the consumer's smartphone. The merchant may obtain the reference number/information by using his/her smartphone to scan the QR code displayed on the consumer's phone.

In a return-of-goods use case, the consumer makes a payment account system transaction payment for the purchase of the goods. The payment network routes the transaction to the merchant bank to credit the merchant's card account that backs the program for transactions of this kind. The merchant bank receives the payment request. The merchant receives notification that the payment transaction has been performed with the notification coming to the merchant's smartphone via a merchant app or as an SMS notification. A number of days later, the consumer comes back to the merchant location to return goods. In this use case, it is assumed that the consumer has no reference to the original transaction. The merchant accepts the returned goods, the merchant may then collect payment information (e.g., the consumer's payment card number or the consumer's digital account reference) and initiates a refund to the consumer's payment card account. A suitable message then is sent from the merchant to the merchant bank to request the refund transaction. The refund transaction is performed and the consumer is notified of the refund transaction via the consumer's smartphone. In some embodiments, instead of the consumer providing the consumer's payment card number, the consumer may provide a mapped consumer identifier. The mapped consumer identifier may originate from a service operated by the payment network or other trusted party that maps the identifier to the consumer's funding account. The merchant may provide the consumer identifier to the merchant bank in requesting the refund transaction. The consumer identifier may be translated to the consumer's account information at the level of the payment network.

In an e-commerce use case, the consumer (e.g., by operating a desktop or laptop computer) registers to pay for goods and services on an e-commerce website. The merchant bank/acquirer/transaction processor initiates a pull transaction to pull from the consumer's card account. The payment network routes the funding transaction to the consumer bank to pull from the consumer's card. The payment network settles funds with the merchant bank in an end of day batch process. The consumer returns the goods through the mail. The merchant receives the goods returned and initiates an immediate refund to credit the consumer card account in real time or near real time. The consumer is notified that the funds have been returned.

In a funds transfer use case (i.e., a P2P payment or disbursement), the sending consumer or company sends instant funds to a recipient's card account. The sending person's wallet may be backed by a card account or a non-card account. The payment network routes the funds transfer transaction to credit the recipient's card account. The recipient's bank credits the recipient's account instantly. The recipient receives the funds. The recipient (it is assumed) was not expecting the payment and wants his/her bank to return funds to the sender. The recipient's bank uses a refund transaction to refund the transferred amount to the sender. The sender receives a notification to indicate that the funds have been returned.

Referring again to blocks 404 and 406 in FIG. 4, additional details and/or alternative examples relative to those process steps will now be described.

According to one alternative, the consumer bank may access an API to request a digital account reference for a consumer wallet backed by a bank deposit account or stored value account. The payment network may generate the requested digital account reference and transmit it to the consumer bank. The consumer bank may store the digital account reference in mapped relationship to the wallet funding account. The consumer bank may need to manage the expiration date for the digital account reference; for example, the consumer bank may follow a practice of requesting a new digital account reference (or new digital account reference expiration date) for the funding account not less than 90 days before the currently effective expiration date. In some embodiments, the digital account reference may not have an expiration date.

According to another alternative, the consumer bank may use a network connection to the payment network to request the digital account reference via a non-financial network message.

According to still another alternative, the consumer bank itself may generate a digital account reference for the wallet funding account.

Further to the above discussion of block 408, additional detail will now be provided as to example transactions performed in accordance with aspects of this disclosure. The discussion now relates to QR transactions, P2P funds transfers, and perhaps other types of transactions as well.

In this/these example(s), a consumer's or sender's bank may initiate a transaction (i.e., a push payment) to a merchant or funds transfer recipient via an API interface or an MIP interface. The message may include the number of the original funding account (e.g., bank account number or PAN (in the case of a payment system account) or a token PAN or mobile money account reference number) and an additional data field that carries a digital/virtual account reference number. If the funding source is a payment system account for the system that is being used in the transaction, then the PAN may be copied by the payment network into the additional account reference field referred to just above. The merchant/recipient bank then receives the transaction, with the relevant refund card information (digital account reference or actual PAN) available in the additional field (regardless of funding source) so as to minimize the burden on the merchant bank with respect to refunds. That is, the merchant bank can use the account number in the additional field to route the refund, and need not be concerned with the type of the original funding account to which the refund is to be sent. A pull transaction from the consumer's account may be involved to fund the push payment to the merchant.

Further to the discussion of blocks 410 and 412, additional detail will now be provided as to example refund transactions performed in accordance with aspects of the disclosure.

In this/these example(s), a merchant/recipient's bank initiates a refund to the sender/consumer through an API interface or an MIP interface. The refund request message includes the digital account reference. The digital account reference is used to route the refund to the consumer bank. The payment network applies interchange (i.e., reverses the interchange from the original transaction that is now being refunded). The payment network updates the funding account number and the funding source. The sender/consumer's issuer/bank receives a payment transaction. The sender/consumer's funding account is credited based on mapping at the sender/consumer's bank or data included in the message about the original funding account and funding source. The type of the original transaction is provided so that appropriate interchange and pricing are applied to the refund transaction. There is also suitable reporting to differentiate among types of transactions.

According to another example, or way of viewing blocks 410 and 412, the merchant bank performs a refund transaction with a specific transaction code that identifies the transaction as a real time refund to the PAN or digital account reference. The consumer bank receives the refund request and transmits a notification to the consumer. The refund authorization message identifies the transaction as a “QR” refund. The consumer receives the notification.

In another example or set of examples, the consumer bank (for an original transaction) serves as an originating institution and the payment network performs an on-behalf service by issuing digital account references for funding accounts that are not payment system accounts. The consumer bank initiates a payment to the merchant through an API or MIP interface. The transaction message includes an identification of the original funding account (bank account number, stored value account, payment system account or a payment system account issued for another payment network). The payment network performs an on-behalf service to identify if the funding source is a bank account; the payment network includes a digital account reference in the message to the merchant. The network will determine the best option to assign a new digital account reference or to reuse a digital account reference that has previously been associated with the funding bank account. The payment network routes the payment to the merchant with the digital account reference. The consumer bank receives (from the merchant bank) the pseudo 16 digit reference number in the response.

If a refund is to take place, the merchant bank performs a refund authorization with a message type indicating a real time refund transaction to be made to the card account (virtual or regular). The network routes the refund to the digital account reference. The network also includes the funding source and the funding account number. The consumer bank receives the refund request. The refund authorization identifies the transaction as a “QR” refund. The consumer bank provides notification to the consumer. The merchant bank submits clearing to the network.

In another example or set of examples, a wallet service provider (WSP) or a third party originating bank serves as an originating institution (for an original transaction) and the payment network performs an on-behalf service by issuing digital account references for funding accounts that are not payment system accounts. The WSP/OI initiates a payment to the merchant through an API or MIP interface. The transaction message includes an identification of the original funding account (bank account number, stored value account, payment system account or a payment system account issued for another payment network). The payment network performs an on-behalf service to identify if the funding source is a bank account; the payment network includes a digital account reference (virtual bin range for a third party OI) in the message to the merchant. The network will determine the best option to assign a new digital account reference or to reuse a digital account reference that has previously been associated with the funding bank account. The payment network routes the payment to the merchant with the digital account reference. The originating bank receives (from the merchant bank) the digital account reference in the response.

If a refund is to take place, the merchant bank performs a refund authorization with a message type indicating a real time refund transaction to be made to the card account (virtual or regular). The network routes the refund to the digital account reference. The network also includes the funding source and the funding account number. The originating bank/WSP receives the refund request and notifies the consumer. The refund authorization identifies the transaction as a “QR” refund. The merchant bank submits clearing to the network.

In another example, a WSP or third party originating bank serves as originating institution and supports funding from all cards issued for the payment network but does not leverage tokenization; it is assumed that the consumer bank and the originating institution are different entities. The WSP/third party OI initiates a payment to the merchant through an API interface or an MIP interface. The message includes the original funding account, assumed to be a payment system account for the payment network. The payment network routes payment to the merchant with the payment network payment system account as funding source. The originating institution receives the status in the response.

If a refund is to take place, the merchant bank performs a refund authorization with a message type indicating a real time refund transaction to be made to the funding payment system account. The consumer bank (card account issuer) receives the refund request.

To address a possible issue that the third party has no direct visibility into refunds, the third party OI may be enabled to register each funding account using a service provided by the payment network with the consumer's wallet information. On a refund request, the payment network may check the funding PAN mapping and notify the third party/WSP.

In the payment system 200, there may be two (or more) different refund transaction types. One of the transaction types may be a conventional refund transaction performed in a customary manner. The other refund transaction type may be a real time payment transaction with a mandate to the consumer bank to notify the customer immediately and to credit the (original-transaction-) funding account in real time or near real time. Customary dispute resolution systems and practices may apply to the real time refund transaction type. The merchant bank may be required to support a transaction authorization request that calls for real time notification of the consumer. The consumer bank may be required to accept a transaction authorization request of this type on (say) a return transaction and to provide real time notification to the consumer. The wallet application should display the pending refund approval from the merchant.

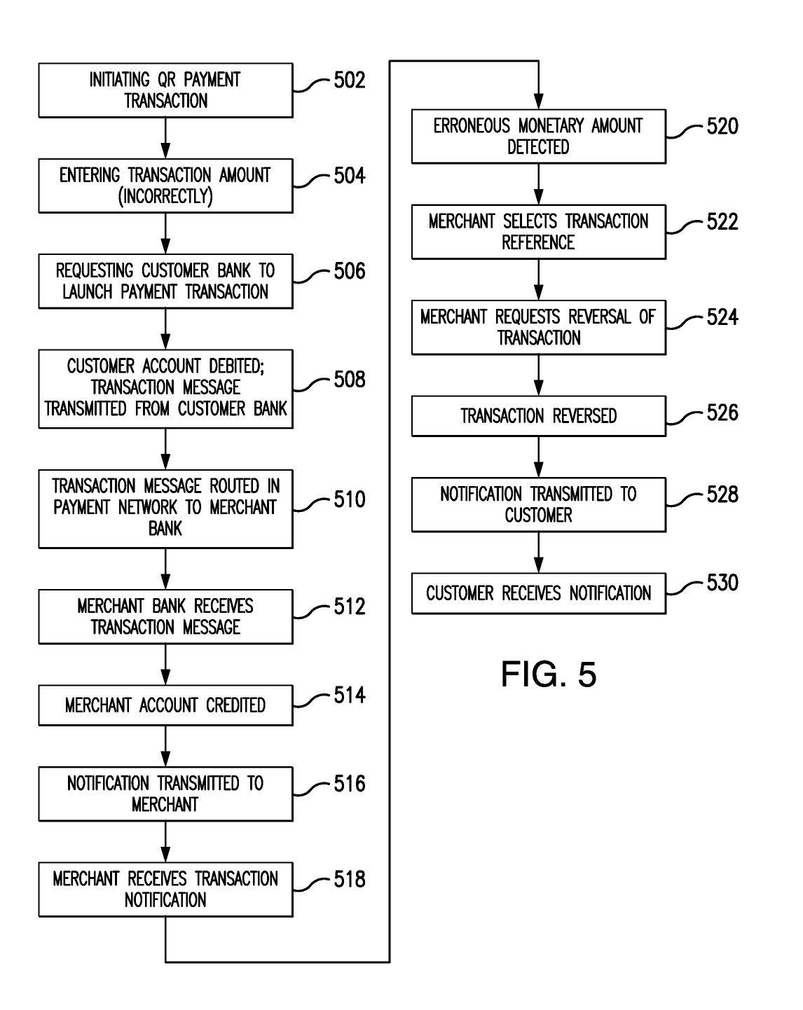

FIG. 5 is a flow chart that illustrates an example process that may be performed in the payment system 100 of FIG. 1. The ensuing description of FIG. 5 may be considered an elaboration on portions of the process framework illustrated in FIG. 4.

Referring now to FIG. 5, at 502 a customer initiates a QR payment transaction at a point of sale. This may occur by the customer using his/her mobile device to scan a static QR code displayed by the merchant (e.g., on a placard). As is well known to those who are skilled in the art, the QR code may contain data that identifies the merchant and the merchant payment system account to which the payment is to be made.

At 504, the customer is prompted by his/her mobile device to enter the monetary amount that is due to settle the purchase transaction that is occurring at the point of sale between the customer and the merchant. For purposes of this illustration of a refund transaction, it is assumed that in this underlying transaction the customer enters the transaction amount erroneously.

At 506, the customer operates his/her mobile device to transmit a request to the customer bank to launch the desired payment transaction to benefit the merchant in connection with the current purchase transaction.

At 508 the customer bank receives the request, debits the customer's account for the (erroneous) transaction amount, and generates and transmits a transaction message to cause the desired payment transaction to occur.

At 510, the transaction message transmitted by the customer bank is routed in the payment network to the merchant bank.

At 512, the merchant bank receives the transaction message.

At 514, the merchant bank credits the (erroneous) transaction amount to the merchant's account.

At 516, the merchant bank transmits to the merchant's device a notification that the payment transaction occurs. The notification includes the erroneous transaction amount.

At 518, the merchant's device receives the transaction notification.

At 520, the merchant (or the customer) notices that the transaction amount stated in the notification is incorrect. The merchant recognizes that there is a need to reverse the transaction indicated in the notification received at 518.

At 522, the merchant interacts with his/her mobile device to select the transaction reference that corresponds to the transaction for which the notification was received at 518. This may involve the merchant clicking on the transaction reference as it is displayed on the touchscreen of the merchant's mobile device.

At 524, using the selected transaction reference, the merchant requests that the payment transaction of steps 502-518 be reversed. This may involve the merchant clicking on a “reverse transaction” option that pops up on the device touchscreen when the merchant selects the transaction reference at step 522. The merchant's request results in a message being sent from the merchant's mobile device to the merchant bank requesting the reversal of the transaction.

At 526, the payment transaction of steps 502-518 is reversed. This may come about by messaging in the payment network initiated by the merchant bank.

At 528, a notification is transmitted from the customer bank to the customer's mobile device to indicate that the payment transaction of steps 502-518 has been reversed.

At 530, the customer's mobile device receives the notification indicating that the payment transaction of steps 502-518 has been reversed.

In further steps that may occur, but are not indicated in FIG. 5, the customer may initiate a new payment transaction, by—e.g.—scanning the QR code again and taking care to enter the correct transaction amount.

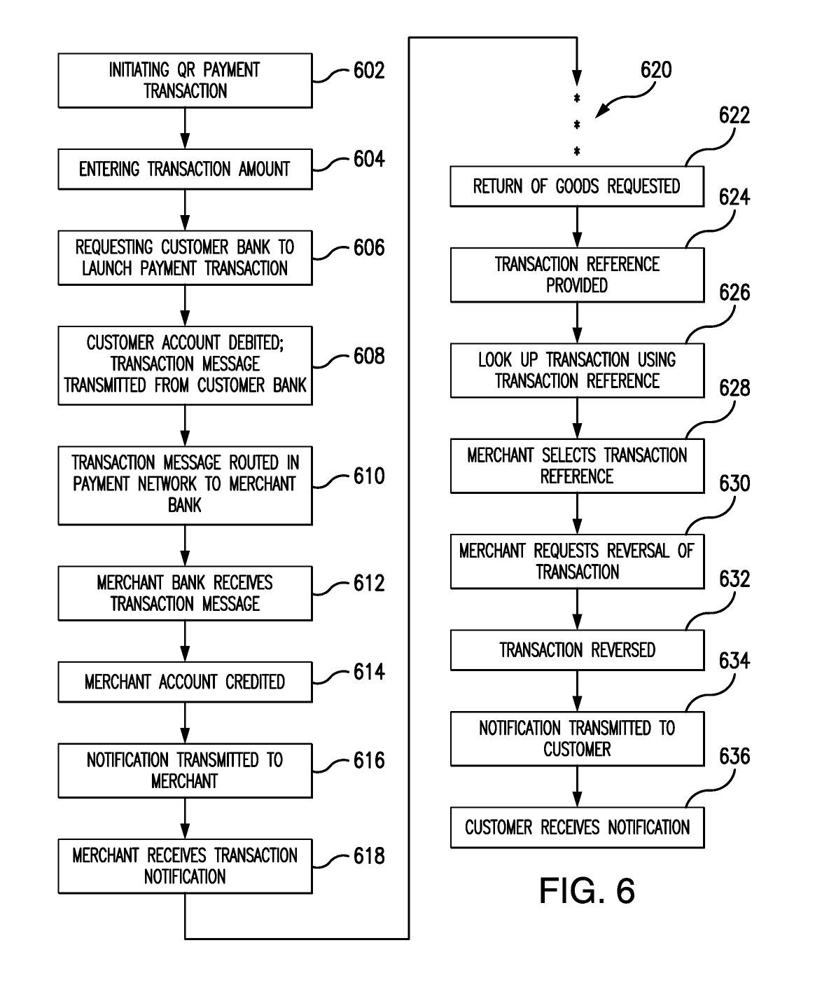

FIG. 6 is a flow chart that illustrates another example process that may be performed in the payment system 100 of FIG. 1. The ensuing description of FIG. 6 may be considered an elaboration on portions of the process framework illustrated in FIG. 4.

The above description of steps 502-518 in FIG. 5 is also applicable to describe steps 602-618, respectively, in FIG. 6, but with the important difference that for step 504 in FIG. 5 it was assumed that the customer incorrectly entered the transaction amount, whereas for step 604 in FIG. 6, it is assumed that the customer entered the transaction amount correctly.

With the completion of step 618 in FIG. 6 (i.e., completion of the payment transaction), the customer may depart from the point of sale with the item or items purchased. According to FIG. 6, there is then a lapse of time (perhaps a few days), represented by an ellipsis 620. Following is block 622, at which the customer returns to the merchant's premises and requests to return the goods purchased and paid for by the payment transaction of steps 602-618.

At 624, the customer provides to the merchant a transaction reference that corresponds to the payment transaction of steps 602-618. This may be done in a number of ways. For example, the customer may operate his/her mobile device to send a text message to the merchant's mobile device, where the text message includes the transaction reference. Alternatively, the customer may cause his/her mobile device to display a QR code that contains the transaction reference. The merchant may then use his/her mobile device to scan the QR code to obtain the transaction reference. Other possibilities include the customer causing his/her mobile device to display the transaction reference as a human readable character string. The merchant may view the character string and enter the transaction reference accordingly into the merchant's mobile device.

At 626, the merchant may operate his/her mobile device to look up the corresponding payment transaction using the transaction reference. It is assumed that the look-up operation is within transaction data stored in the merchant's mobile device, though this need not necessarily be the case. At this point, the merchant is prepared to cause the payment transaction of steps 602-618 to be reversed, to reflect the customer's return of the goods purchased.

At 628, the merchant interacts with his/her mobile device to select the transaction reference for the looked-up payment transaction. This may involve the merchant clicking on the transaction reference as it is displayed on the touchscreen of the merchant's mobile device within the context of the looked-up payment transaction.

At 630, using the selected transaction reference, the merchant requests that the payment transaction of steps 602-618 be reversed. This may involve the merchant clicking on a “reverse transaction” option that pops up on the device touchscreen when the merchant selects the transaction reference at step 628. The merchant's request results in a message being sent from the merchant's mobile device to the merchant bank requesting the reversal of the transaction.

At 632, the payment transaction of steps 602-618 is reversed. This may come about by messaging in the payment network initiated by the merchant bank.

At 634, a notification is transmitted from the customer bank to the customer's mobile device to indicate that the payment transaction of steps 602-618 has been reversed.

At 636, the customer's mobile device receives the notification indicating that the payment transaction of steps 602-618 has been reversed. The return of goods is now complete, with the purchase price amount having been refunded to the customer's account.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The above descriptions and illustrations of processes herein should not be considered to imply a fixed order for performing the process steps. Rather, the process steps may be performed in any order that is practicable, including simultaneous performance of at least some steps and/or omission of one or more steps.

As used herein and in the appended claims, the term “payment card system account” includes a credit card account or a deposit account that the account holder may access using a debit card. The terms “payment card system account” and “payment card account” and “payment system account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card or a debit card.

Although the present disclosure has been described in connection with specific example embodiments, it should be understood that various changes, substitutions, and alterations apparent to those skilled in the art can be made to the disclosed embodiments without departing from the spirit and scope of this disclosure.

What is claimed is:

1. A method comprising:
associating a digital account reference with a user's account;
receiving a refund message, said refund message including said digital account reference, said refund message being a push payment message originating from a merchant's bank, said push payment message received via a payment card account system network, said push payment message formatted in a standard message format prescribed by the payment card account system;
decoding the digital account reference to obtain account information that identifies the user's account;
crediting a monetary amount to said user's account based on said received refund message; and
transmitting a notification about the crediting to the user; said notification transmitted immediately after said receiving step.

2. The method of claim 1, wherein said user's account is a deposit account maintained at a bank.

3. The method of claim 1, wherein said associating step includes generating said digital account reference.

4. The method of claim 1, wherein said associating step includes receiving a digital account reference message prior to receiving said refund message, said digital account reference message received at a bank computer and including said digital account reference, said digital account reference generated by a computer other than the bank computer.

5. The method of claim 4, wherein said digital account reference message is received from an operator of a payment network.

6. The method of claim 4, wherein said digital account reference message is received from a service provider other than an operator of a payment network.

7. The method of claim 1, wherein said refund message is received via a payment network.

8. The method of claim 7, wherein said refund message originated at a merchant's bank.

9. A method comprising:
receiving a transaction notification in a mobile device, the transaction notification corresponding to a payment transaction;
detecting an erroneous monetary amount in the received transaction notification;
operating the mobile device to select a transaction reference that corresponds to the payment transaction; and
using the selected transaction reference to initiate, with the mobile device, a request to reverse the payment transaction.

10. The method of claim 9, wherein the step of operating the mobile device includes clicking on the transaction reference, the transaction reference having been displayed on a display element of the mobile device.

11. The method of claim 9, further comprising:
prior to the receiving step, displaying a QR (quick response) code for scanning by a customer to aid in initiating said payment transaction.

12. The method of claim 9, wherein the detecting step is performed by or on behalf of a merchant who operates the mobile device.

13. The method of claim 12, wherein the request is transmitted by the mobile device to a bank that provides services to the merchant.

14. The method of claim 13, wherein the transaction notification was received in the mobile device from said bank that provides services to the merchant.

15. A method comprising:
receiving a transaction notification in a mobile device, the transaction notification corresponding to a payment transaction;
receiving a request from a customer to return goods paid for by the payment transaction;
using a transaction reference to look up the payment transaction in the mobile device;
selecting the transaction reference; and
using the selected transaction reference to initiate, with the mobile device, a request to reverse the payment transaction.

16. The method of claim 15, wherein the mobile device is a first mobile device, the method further comprising:
prior to looking up the payment transaction, using the first mobile device to read a QR (quick response) code displayed on a second mobile device, the QR code including said transaction reference.

17. The method of claim 15, further comprising:
prior to looking up the payment transaction, receiving a text message in the mobile device, the text message including said transaction reference.

18. The method of claim 15, further comprising:
prior to the receiving steps, displaying a QR (quick response) code for scanning by the customer to aid in initiating said payment transaction.

19. The method of claim 15, wherein the mobile device is operated by a merchant; and
the request to reverse the transaction is transmitted by the mobile device to a bank that provides services to the merchant.

20. The method of claim 19, wherein the transaction notification was received in the mobile device from said bank that provides services to the merchant.
